(19) United States
(12) Patent Application Publication
(10) Pub. No.: US 2013/0346379 A1
(43) Pub. Date: Dec. 26, 2013

(54) STREAMING DYNAMICALLY-GENERATED ZIP ARCHIVE FILES

(71) Applicants: W. Andrew Loe, Seattle, WA (US); Brian Moran, Preston, WA (US); Charles Mount, Issaquah, WA (US)

(72) Inventors: W. Andrew Loe, Seattle, WA (US); Brian Moran, Preston, WA (US); Charles Mount, Issaquah, WA (US)

(21) Appl. No.: 13/531,105

(22) Filed: Jun. 22, 2012

(51) Int. Cl. G06F 17/30; G06F 15/16

(52) U.S. Cl. 707/693; 707/E17.005

(57) ABSTRACT

A method and system for streaming dynamically generated Zip archive file content using a standard, non-streaming Zip archive format. In response to a request from a client to receive one or more files, a Zip archive file is dynamically generated that includes at least one file that is altered while servicing the request, wherein the size of the altered file is unknown prior to completion of the alteration operation. For a Zip file entry corresponding to an altered file, a local file header including an overestimated file size and predetermined CRC32 value is generated. After alteration, the file entry content is adjusted using padding and a CRC32 adjustment such that the length and CRC32 values for the resulting Zip file entry match the overestimated file size and predetermined CRC32 value. Examples of file alteration operations include watermarking, compressing, and/or encrypting the file content.

### FIELD OF THE INVENTION

The field of invention relates generally to data transfers over computer networks and, more specifically but not exclusively relates to techniques for streaming dynamically-generated Zip archive file content.

### BACKGROUND INFORMATION

The Internet has become the preferred medium for transferring digital content, including transfer of electronic documents and streaming media. On a daily basis, billions of pieces of digital content are transferred, typically in unencrypted format. Moreover, the Internet, or more particularly the World Wide Web, has no physical borders, and is available world-wide, wherein a user from anywhere in the world can access content from anywhere else in the world (sans situations such as government blocking access to content). This enables nefarious suppliers of pirated digital content to set up shop using servers in countries with little policing, while serving the content worldwide.

Current technologies for creating, distributing, and consuming digital media generally provide the capability to associate metadata with content; however, too often it does not survive transformations and can easily be stripped—maliciously or unintentionally. In the absence of reliable identification, content can more easily be copied, shared, altered, re-purposed and even sold without the permission or knowledge of its legal owners.

The very nature of electronic of digital content is that it is portable, and thus easily exchanged. This has created quite a problem for publishers of various types of copyrighted content, such as music, videos, books, etc. In response, various techniques for restricting access to unlicensed users of such content have been employed, with mixed success. The techniques generally fall into two categories: digital rights management and digital watermarking.

Digital rights management (DRM) is a class of access control technologies that are used by hardware manufacturers, publishers, copyright holders and individuals with the intent to limit the use of digital content and devices after sale. DRM generally covers any technology that inhibits uses of digital content that are not desired or intended by the content provider. DRM also includes specific instances of digital works or devices. In 1998 the Digital Millennium Copyright Act (DMCA) was passed in the United States to impose criminal penalties on those who make available technologies whose primary purpose and function is to circumvent content protection technologies.

The implementation of DRM has been received favorably by content providers, but is generally not popular with consumers and is not without controversy. Content providers claim that DRM is necessary to fight copyright infringement online and that it can help the copyright holder maintain artistic control or ensure continued revenue streams. Those opposed to DRM contend there is no evidence that DRM helps prevent copyright infringement, arguing instead that it serves only to inconvenience legitimate customers, and that DRM helps big business stifle innovation and competition. Further, works can become permanently inaccessible if the DRM scheme changes or if the service is discontinued. Proponents argue that digital locks should be considered necessary to prevent “intellectual property” from being copied freely, just as physical locks are needed to prevent personal property from being stolen.

In contrast to the in your face nature of DRM, digital watermarking is considered a passive means for protecting digital content. Digital watermarking involves a process of embedding imperceptible digital information into various forms of content, including images, documents, audio and video. Because the watermark is imperceptible, it will not interfere with consumers' enjoyment of the content they consume. Once embedded, the watermark persists with the content through manipulation, copying, compression, file conversions and virtually any other transformation that digital content can undergo. The watermark can carry information that allows the content itself to “communicate” where it comes from, who owns it, how it may be used, and whatever other information the holder of copyright wishes to convey.

Websites and web-hosted services (e.g., cloud-based services) often enable users to download multiple files at a time. Rather than return the files individually, which requires additional HTTP traffic overhead and is less convenient for the recipient, an archive file is generated containing the files. The archive file is then downloaded to the requester's computer, typically using TCP/IP over HTTP. Various file archiving schemes may be employed, but the most common archiving services employ what is referred to as the “Zip” archive format. The format was originally created in 1989 by Phil Katz, and was first implemented in PKWARE's PKZIP utility. However, the “PK” aspect of name has generally been dropped in favor of the simpler “Zip,” which is employed as a generic reference to various types of archiving schemes, including PKZIP, GZIP, and WinZIP, and others that generally reference “Zip” in one form or another. The Zip format may be used to archive one or more files in a single archive file, wherein the file content may be stored with or without compression. Support for accessing content stored in Zip files is generally provided by today's operating systems, including Microsoft Windows and Apple's OS X operating systems, using an applicable file archive utility application or module.

FIG. 1 shows the basic structure of a Zip archive file format containing multiple file entries. A Zip file is identified by the presence of structured information fields interspersed with (compressed/uncompressed, encrypted/unencrypted) file contents, and a central directory of all file information that is located at the end of the file structure to facilitate appending new files and/or folder/file structures to the archive. As shown in FIG. 2a, the central directory stores a list of the names of the entries (files or directories) stored in the Zip file, along with other metadata about the entry, and an offset into the Zip file, pointing to the actual entries, each of which contains associated file data. This allows a file listing of the archive to be performed relatively quickly, as the entire archive does not have to be read to see the list of files. Local file headers for each entry in the Zip file also include this information for redundancy. Following the central directory file header is an end of central directory file header, as shown in FIG. 2b.

Each entry in the Zip archive format is introduced by a local file header with information about the file such as a comment, file size and file name, followed by optional “Extra” data fields, and then the possibly compressed, possibly encrypted file data. The format of the standard Zip archive local file header is shown in 2c. The “Extra” data fields support extensibility of the zip format. “Extra” fields are exploited to support the ZIP64 format, WinZip-compatible AES encryption, file attributes, and higher-resolution NTFS or Unix file timestamps. Other extensions are possible via the “Extra” field. Zip utilities are required by the Zip archive specification to ignore Extra fields they do not recognize.

The local Zip file header information includes a file size (in bytes) and a 4-byte CRC32 value for each entry, as shown in FIGS. 2c and 3a. CRC32 stands for a 32-bit Cycle Redundancy Cycle value that is calculated as a function of a file's content. In brief, the CRC32 value is derived using a standardized algorithm that is widely used for transmission of digital content over networks. At the receiving end, a second CRC32 value is calculated based on the received data, and the original CRC value(s) embedded in the file headers are compared with the corresponding CRC32 calculations based on the received data to determine whether they match. If they match, it is presumed the file content was transferred without error; otherwise, non-matching CRC32 values are indicative that potential errors occurred during transmission.

In response to a request for multiple files, it is preferable to start “streaming” the archive file content immediately, if possible. This is generally not a problem for downloads of multiple files that are stored in an original form that is not modified prior to being added to a dynamically-generated Zip file (or for situations where an applicable Zip file is already cached) since CRC32 and size values can be stored along with the original content. However, when one or more of the files is to be dynamically watermarked (e.g., for ownership or tracking purposes), this immediate delivery scheme may not be successful. Before the watermark operation, it is not particularly easy or feasible to determine to the exact size in bytes of the resulting watermarked file, nor is it possible to ascertain what a CRC32 calculation on the file will return.

One solution to this situation is to use a streaming Zip format, such as ZipStream. This technique enables a sender to create a Zip archive on the fly and stream it to the client as each file added to the archive in a dynamic manner. As shown in FIG. 3b, the streaming Zip format does not require file size and CRC32 values to be included in local file headers, but rather these values are included in a data descriptor appended to the end of each file content entry, details of which are shown in FIG. 2d. This enables file content to be streamed without requiring full file header information including file size and CRC32 to be calculated prior to sending the file; rather these values can be dynamically calculated as the file data is being streamed and included in the appended data descriptor. Use of this format is indicated by setting bit 3 (0×08) of the general purpose flags field in the local file header.

While the streaming Zip format enables immediate streaming of zipped content, it is not supported by some utilities employed for reading/extracting Zip file content, such as the default archive utility in Apple OS X. As a result, depending on how a Zip file configured in the streaming Zip format is opened, it may not be extracted correctly. In particular, this currently occurs when a Zip file using the streaming Zip format is opened using Finder, which is OS X's default file management application. In view of this and other deficiencies with current techniques, it would be advantageous to be able to immediately stream Zip files that are dynamically generated and configured in accordance with the standard Zip format rather than a streaming ZIP format.

### SUMMARY OF THE INVENTION

In accordance with aspects of the present invention, methods and systems for streaming dynamically generated Zip archive file content using a standard, non-streaming Zip archive format are provided. In response to a request from a client to receive one or more files, a Zip archive file is dynamically generated that includes at least one file that is altered while servicing the request, wherein the size of the altered file is unknown prior to completion of the alteration operation. For a Zip file entry corresponding to an altered file, a local file header including an overestimated file size and predetermined CRC32 value is generated. After alteration, the file entry content is adjusted using padding and a CRC32 adjustment such that the length and CRC32 values for the resulting Zip file entry match the overestimated file size and predetermined CRC32 value. Examples of file alteration operations include watermarking, compressing, translating, annotating, and/or encrypting the file content. Use of the standard Zip archive format enables the streamed file content to be accessed using any archive utility that supports the format.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 shows the format of a standard Zip archive file;

FIG. 2a shows the structure of a central directory file header in accordance with the standard Zip archive file format;

FIG. 2b shows the structure of a the end of the central directory file header in accordance with the standard Zip archive file format;

FIG. 2c shows the structure of a local file header in accordance with the standard Zip archive file format;

FIG. 2d shows the structure of a data descriptor used in a Zip archive streaming format;

FIG. 3a shows additional details of the standard Zip archive file format with emphasis on the size and CRC32 values in the local file headers;

FIG. 3b shows a format employed by a streaming Zip archive format;

FIG. 4a a combination system architecture and message flow diagram illustrating operations performed by system components in response to servicing a client request for an archive including two files;

FIG. 4b is a message flow diagram illustrating further details of the Zip archive file content streamed to the client from a Web server;

FIGS. 5a and 5b comprise a flowchart illustrating operations performed in response to a client file request under which a standard Zip archive file is dynamically generated that includes watermarked versions of the requested files that are produced while servicing the request;

FIG. 6a depicts original file contents for an exemplary file;

FIG. 6b depicts an alternation in the original file after a watermarking operation has been performed on the original file contents;

FIG. 6c shows adjustment to the altered file content such that the size and CRC32 values for the adjusted altered file contents correspond to an overestimated size and predetermined CRC32 value included in a local file header for a Zip archive file entry corresponding to the adjusted altered file contents; and

FIG. 7 is a flowchart illustrating operations for generating a Zip archive file entry having a predetermined CRC32 value.

### DETAILED DESCRIPTION

Embodiments of methods and apparatus for streaming Zip file content are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the invention, techniques are disclosed that facilitate immediate streaming of a dynamically-generated Zip archive files having one or more file entries, wherein the received content after the streamed content is completed is formatted as a conventional Zip file rather than having a streaming Zip format. As a result, the received Zip file can be handled by any archiving utility that is configured to work with standard Zip files (that is, compliant with the standard Zip file format).

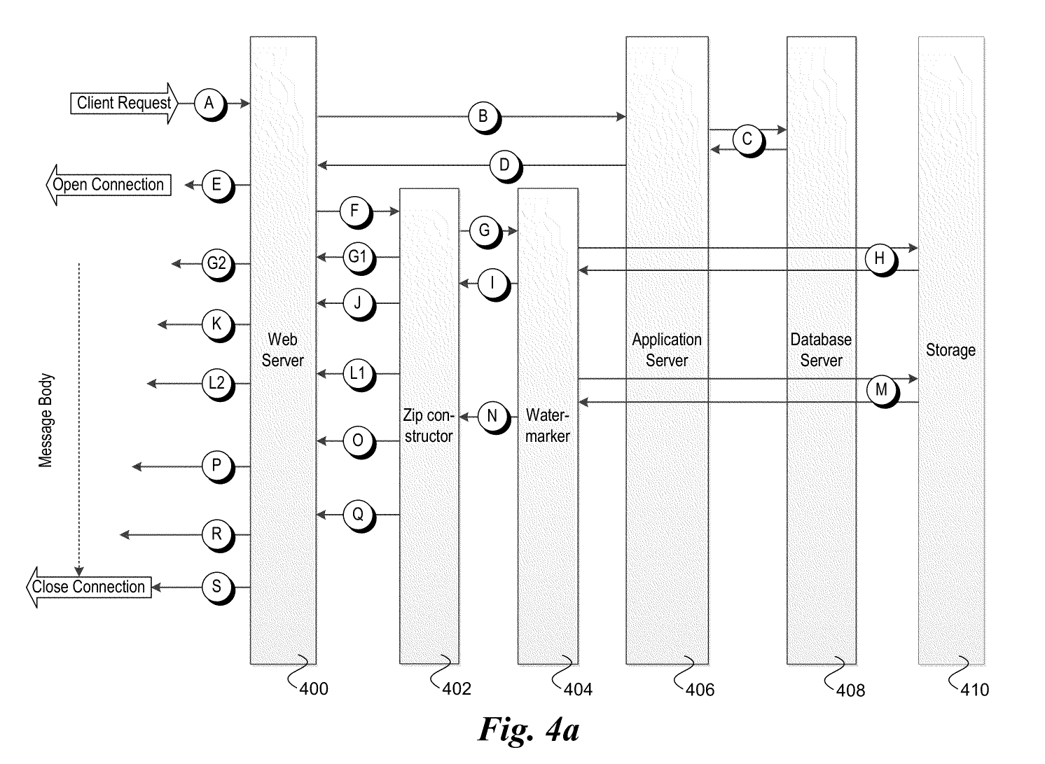

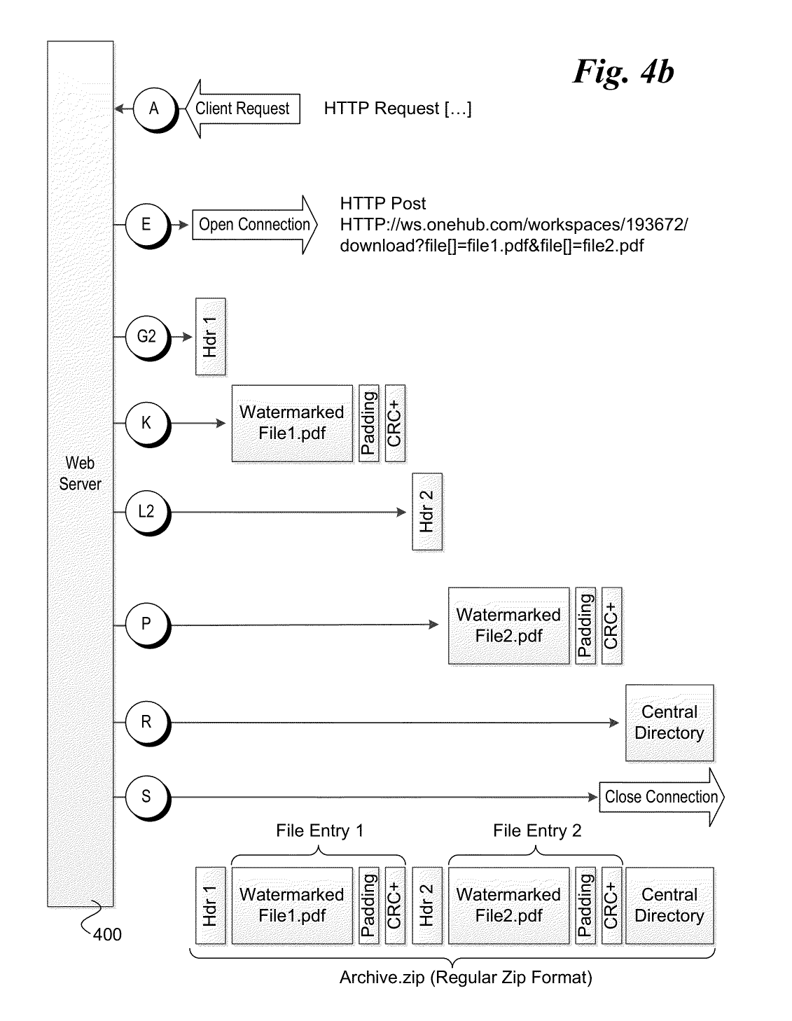

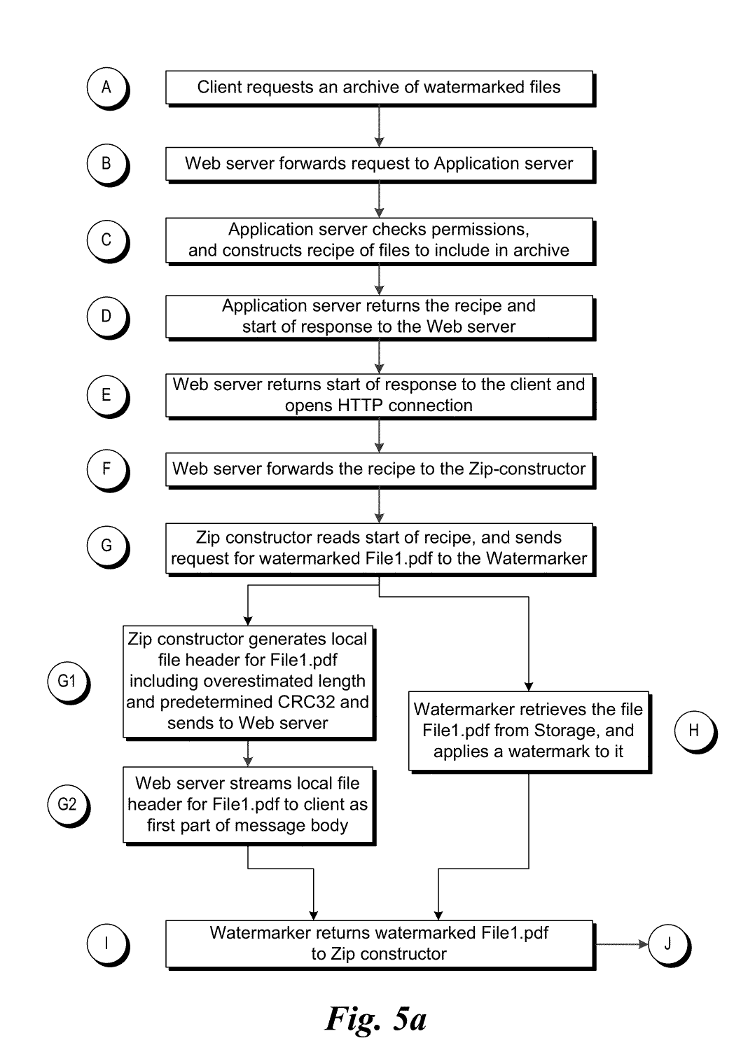

FIG. 4a shows a workflow diagram including an exemplary server-side architecture for servicing client requests for dynamically-generated file archives, according to one embodiment. The server-side architecture includes multiple tiers, depicted as a Web server 400, a Zip constructor 402, a Watermarker 404, an Application server 406, a database server 408, and storage 410. Operations associated with each of these tiers may be performed by one or more machines (e.g., servers), and/or operations for multiple tiers may be performed by a single machine or a set of machines, each configured to perform a set of operations. For example, an Application server or Application server tier implemented with multiple machines may host the operations of Zip constructor 402 and/or Watermarker 404 via execution of corresponding software modules or the like. In addition, one or more servers may be configured to host multiple virtual machines that are used to run various software applications and/or modules for facilitating the operations described herein.

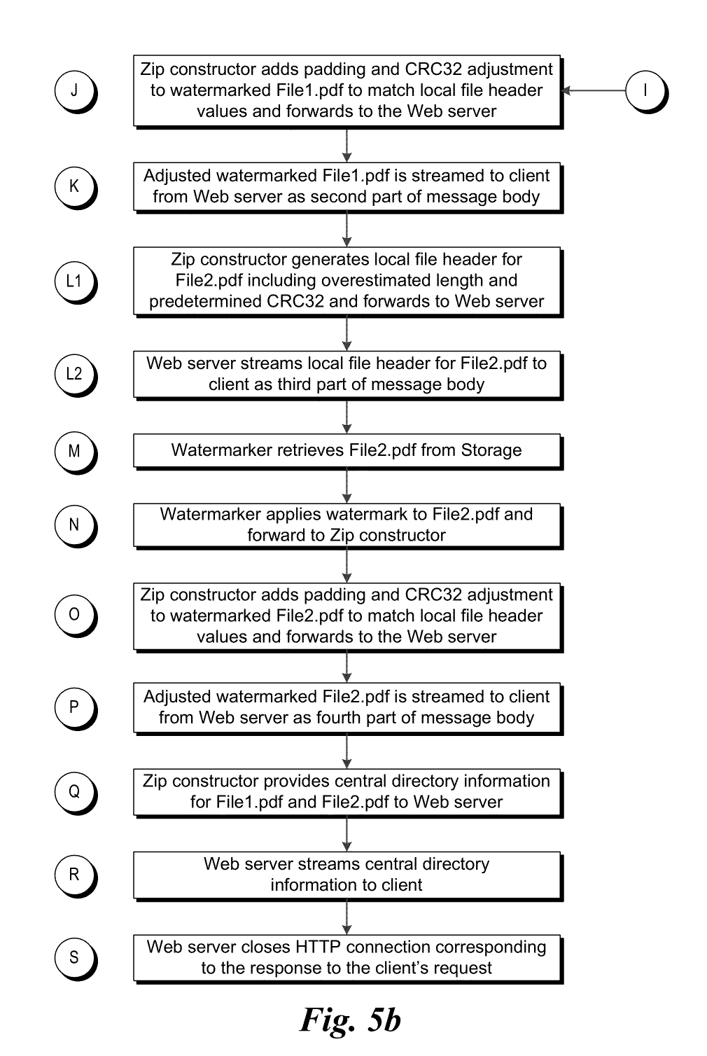

With reference to the time flow diagrams of FIGS. 4a and 4b and the flowchart portions of FIGS. 5a and 5b, one embodiment of a process for dynamically generating and streaming a standard Zip file proceeds as follows. As depicted by an operation A the process starts with a client submitting an HTTP request to a Web server 400 requesting a Zip archive of a particular file or set of files. In this example, the client is requesting an archive of two PDF files named File1.pdf and File2.pdf. In practice, selection of the file or set of files may be facilitated using various techniques such as through use of AJAX code or the like in a Web page via which a user of the client is enabled to select or otherwise specify the file(s). This process involves an interactive exchange of data between the client and Web server hosting the Web page using HTTP messages. Accordingly, it will be understood that the HTTP request shown in FIG. 4b and corresponding to operation A may simply be a last request message at the end of an interactive exchange of messages via which the requested file or files is/are identified.

Next, during an operation B Web server 400 forwards the request to Application server 406. In response to receiving the request, Application server 406 checks one or more permissions to determine if the request is to be serviced, and if so, constructs a “recipe” to generate the Zip archive, as shown in an operation C. This may typically be facilitated via an exchange between Application server 406 and database server 408, which may store data related to the request, such as file permissions, user permissions, file storage locations, cached archives, watermark indicia, etc. In general, the recipe is formulated to specify how the archive file is to be generated and watermarked, and includes additional information to facilitate immediate streaming of the archive file. For example, the recipe may typically contain a list of files to be included in the archive, the location of the files in storage 410, and information relating to the files that may be mapped to corresponding fields in the archive headers, such as file size, file modification times/dates, file attributes, etc.

Following generation of the recipe, application server 406 returns the recipe and start of the response to Web server 400, as depicted by an operation D. The start of the response is then returned to the client via an operation E. The start of the response will typically be in the form of an HTTP Response having an HTTP Response header information applicable information pertaining to the client's request, such as session cookies, etc., that is returned to the client in response to the client request in operation A. In one embodiment, the HTTP Response message includes a dynamically generated recipe which contains location information at which the requested file can be accessed, such as depicted in FIG. 4b. In one embodiment, the HTTP response generated by the application server contains a combination of headers for the client, and a ‘recipe’ to be processed by the web server, such as depicted in FIG. 4b. The special nature of the response (to be handled by the webserver) is indicated by a special header value included by the application server in is response. The webserver recognizes the special form of the response message, and forwards header information to the client awaiting the response, but filtering the response part meant for the web server. Using the recipe information, in some embodiments the start of the response is configured to support transfer of archive file content in the body of an associated HTTP message using a continuous stream or streaming that may have intermittent breaks (e.g., using chunked transfer encoding) send over a persistent HTTP connection. In one embodiment, the HTTP 1.1 protocol is used, which supports persistent HTTP connections by default.

As depicted by an operation F, Web server 400 forwards the recipe to Zip constructor 402 in response to receiving the recipe from Application server 406. Zip constructor 402 reads the beginning of the recipe and sends a corresponding request for watermarking one or more files to be included in the archive to Watermarker 404, as depicted by an operation G. For example, the first portion of the recipe may contain indicia to be included in the watermark, such as a requester's e-mail address or other indicia applicable to watermarking operations.

As show in FIG. 5a, at this stage the flowchart branches to perform parallel operations. In an operation G1, Zip constructor 402 generates a local file header for the first file (File1.pdf), which includes an overestimated length and predetermined CRC32 value, and sends the local file header to Web server 400, which then streams the local file header to the client as the first part of the message body. This is depicted in FIG. 4b as sending data comprising a Hdr 1 to a client (not shown) at operation G2. The purpose of the overestimated length and predetermined CRC32 value is explained below.

During a parallel operation H, Watermarker 404 retrieves the first file identified by the recipe (e.g., File1.pdf in this example) from storage 410. Generally, storage 410 corresponds to any storage facility used to store digital content that may be served to a client in response to a request. Storage 410 may correspond to a local storage facility, or may also correspond to a remote storage facility accessed via a network, such as cloud-based storage and/or storage accessed via a public or private network. Upon retrieval of the file, Watermarker 404 applies a watermark to the file in accordance with indicia specified in the recipe or using a predefined scheme employing one or more of various types of digital watermarking techniques. For example, the watermark could be unique to the request or the requestor and/or may relate to the content and/or the provider of the service. Generally, any type of criteria may be used to determine what watermark data and/or technique is to be employed. In one embodiment, this watermarking criteria is provided, at least in part, by the recipe.

Continuing at an operation I, after the watermarking operating has been performed on the file, the watermarked file is forwarded to Zip constructor 406. In accordance with an operation J, the Zip constructor then adjusts the watermarked file by adding padding and a CRC adjustment so that the size of the adjusted file matches the overestimated length in the local file header and the CRC32 value for the adjusted file matches the predetermined CRC32 value in the local file header. The adjusted watermarked file (File1.pdf) is then returned to Web server 400.

In response to receiving the adjusted watermarked File1.pdf, Web server 400 streams corresponding content to the client, as depicted by an operation K. As shown in FIG. 4b, the content that is streamed includes the watermarked File1.pdf content, which has been lengthened via use of zero padding plus the CRC32 adjustment. This portion of the streamed content corresponds to the second part of the message body. Although the term “part” of the message body is used herein, this is not meant to convey that different potions of content are sent separately, although there may be some instances in which there are delays of short duration between sending of portions of the archive file format. Rather, from the client's perspective, the entire archive file content will be considered to being received as a single stream, according to one embodiment.

At this point, the adjusted watermarked File1.pdf content is being streamed to the client, and the processing operations are implemented on File2.pdf. This follows a similar process flow as implemented for File1.pdf. During the previous operation F, Zip constructor 402 received the recipe for the archive, which includes information pertaining to each file to be added to the archive, including File2.pdf. Accordingly, in an operation L1 Zip constructor 402 generates a local file header for File2.pdf including an overestimated length and a predetermined CRC32 value and sends it to Web server 400, which then streams the local file header for File2.pdf to the client during an operation L2 as the third part of the message body. As shown in FIG. 4b, this is depicted by data labeled Hdr 2 adjacent to operation L2.

During an operation M, Watermarker 404 retrieves File2.pdf from storage 410 based on the location of the file defined in the recipe (or the location is determined by other means, such as requesting the file for a cloud-based storage host), and then applies a watermark to the File2.pdf during an operation N in accordance with applicable watermarking criteria in a manner similar to that performed to watermark File1.pdf. The watermarked File2.pdf is then returned to Zip constructor 402.

As depicted by an operation 0, Zip constructor 402 adjusts the watermarked File2.pdf by adding padding and a CRC adjustment such that the adjusted length and CRC32 values for the resulting file matches the overestimated length and CRC32 values in the local file header for File2.pdf. This operation is similar to that performed during operation J discussed above. The adjusted watermarked File2.pdf is then forwarded to Web server 400, wherein it is streamed to the client during an operation P as the fourth part of the message body. As shown in FIG. 4b, the content that is streamed includes the watermarked File2.pdf content, which has been lengthened via use of zero padding plus the CRC32 adjustment.

At this point, the processing of files to be included in the archive (i.e., File1.pdf and File2.pdf) has been completed, and a corresponding central directory in accordance with the standard Zip format is generated by Zip constructor 402, as depicted by a block Q. The central directory information is then forwarded to Web server 400, which streams it to the client during an operation R. At the completion of the streaming operation, Web server 400 sends an applicable HTTP message to the client to close the HTTP connection, as depicted by an operation S. This completes delivery of the requested files to the client.

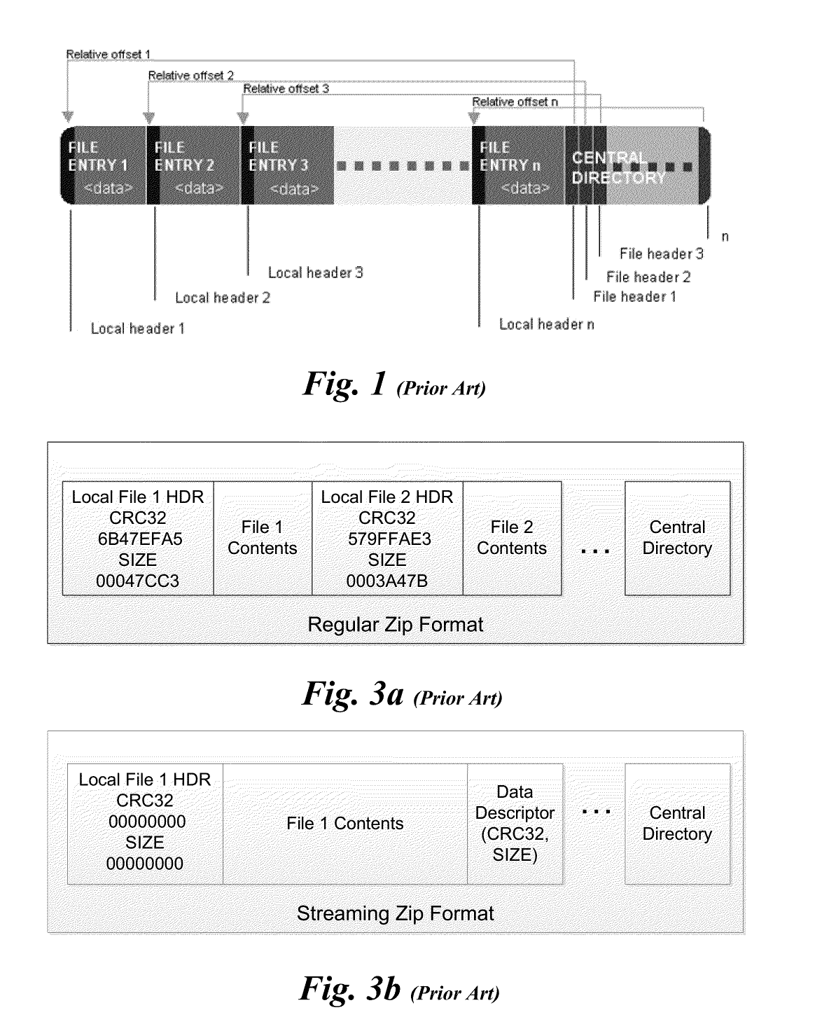

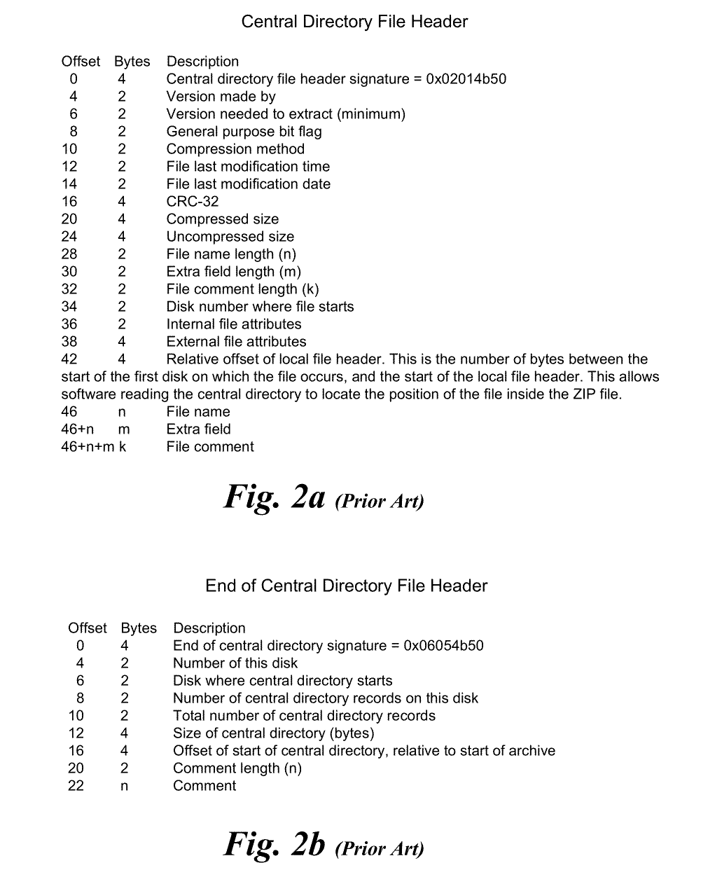

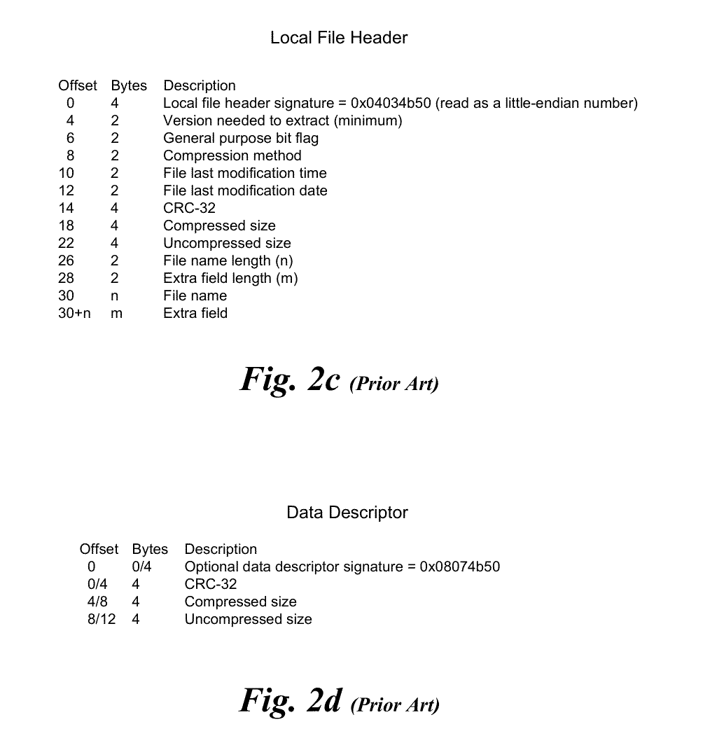

A representation of the content that is streamed to the client is shown at the bottom of FIG. 4b. As illustrated, the streamed content includes a first local file header and a first file entry (Hdr 1 and File Entry 1), followed by a second local file header and second file entry (Hdr 2 and File Entry 2), followed by a central directory. This format is the same as that defined by the standard (i.e., regular, non-streaming) Zip format, as depicted in FIGS. 1 and 3a. As a result, the file content in the archive zip file returned to the client can be extracted by any file archive utility that is configured to work with archive files having a standard Zip format. Thus, the inventive scheme supports dynamic generation of Zip archive content while the content is being streamed, but does not use a streaming Zip format, and thus avoids compatibility issues with file archive utilities that do not work properly with archive files configured in a streaming Zip format.

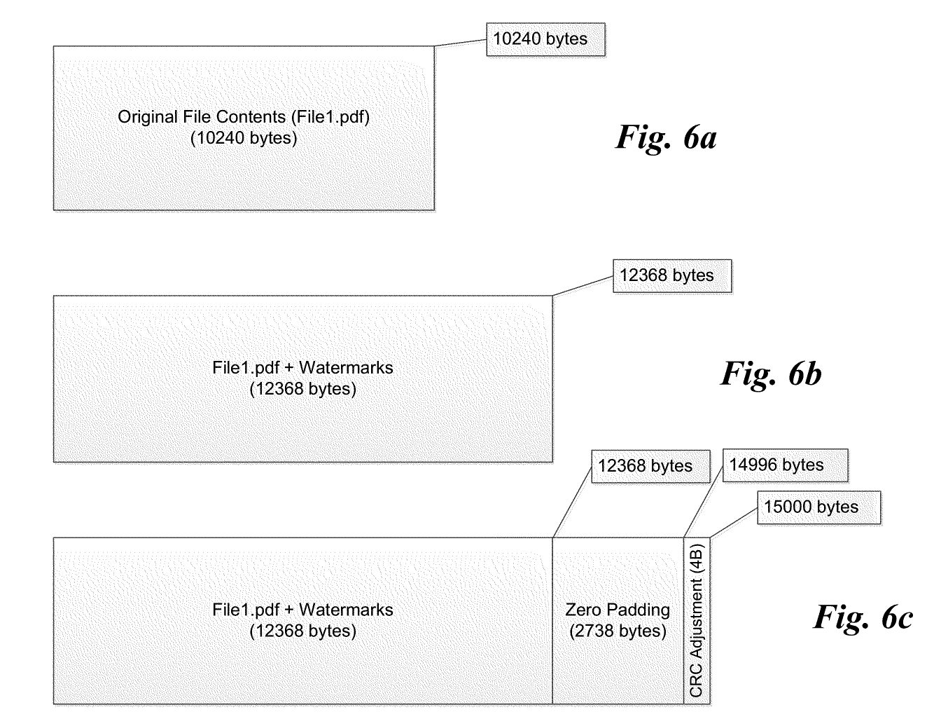

Further details of the file adjustment operations are shown in FIGS. 6a-6c. The process begins with the original file content of File1.pdf, which has an exemplary size of 10240 bytes. This file is to be watermarked, but the size of the watermarked file is difficult to project in advance, since the watermarking augmentations to the file content is a function of the content itself. To accommodate for this, an overestimate of the file size after it has been watermarked and a CRC32 adjustment is added is made. In this example, the overestimated size is 15000 bytes, as depicted in FIG. 6c. This corresponds to the overestimated size that is included in the local file header for the file. In order for the file entry contents to have the same length as defined in the local file header, padding is added to the file entry contents such that the combination of the watermarked file content (FIG. 6b) plus the padding and the CRC32 adjustment equal the overestimated file size. In one embodiment the padding comprises zero padding (i.e., all bit value for all padding bits is ‘0’).

The other aspect of the file adjustment is determining the CRC32 adjustment. The CRC32 for a given file entry will have a value based on the CRC32 algorithm as applied to the file content. When the local file header is generated, the CRC32 value for the corresponding file entry cannot be projected because the final content of the file entry hasn't been generated. In particular, if the watermark criteria are dynamically determined, a watermarked version of the file will not already exist (e.g., there will be no cached version of the watermarked file applicable to the request). Conversely, the standard Zip format local file header includes a CRC32 value. But how can this be determined at this stage?

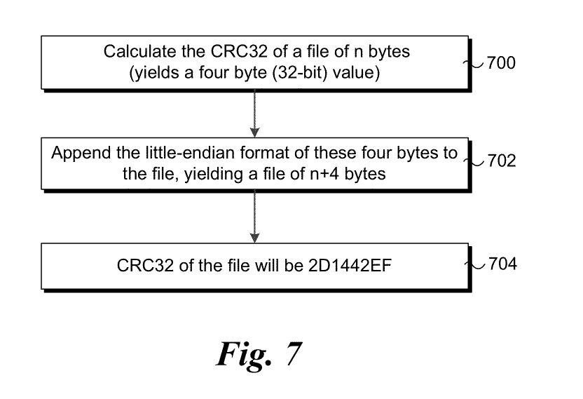

In one embodiment, this problem is solved by employing a predetermined CRC32 value and then adding a CRC32 adjustment at the end of the file entry that is calculated such that the CRC32 for the entire file entry matches the predetermined CRC32 value. In accordance with the flowchart of FIG. 7, the CRC32 adjustment can be determined in the following manner.

The process begins in a block 700, wherein the CRC32 of a file of n bytes is calculated. The calculated value will be a 32-bit (i.e., four byte) CRC. In a block 702 the little-endian format of the four CRC32 bytes is added to the end of the file, yielding a file that is n+4 bytes in length. The result for the CRC32 for the file (of n+4 bytes) will be 2D1442EF (which is determined by the nature of an initialization constant in the CRC32 calculation). Accordingly, this technique may be implemented by employing a CRC32 value of 2D1442EF for each file entry to be included in the archive file. As a corollary operation, the little-endian format of the CRC32 for the file content is appended as the 4 byte CRC32 adjustment at the end of the file.

In accordance with the example file content shown in FIGS. 6a-6c, the operation of block 700 is applied to the portion of the file entry comprising the watermarked file content plus the padding. This is depicted as 14996 bytes in FIG. 6c. As an option, if zero padding is employed, the result of the CRC32 calculation of the watermarked file and the watermarked file with zero padding will be the same, so the CRC32 calculation could be performed on the watermarked file rather than the watermarked file plus the zero padding. In either case, the CRC adjustment derived during the operation of block 702 is appended after the padding, as shown in FIG. 6c. [IN ANOTHER EMBODIMENT, an arbitrary final CRC32 value can be chosen, and a CRC32 adjustment value calculated (according to another algorithm) to yield the arbitrary CRC32 value.

Although the operations of the flowchart portions of FIGS. 5a and 5b are shown and labeled in an ordered manner, this is for ease of explanation and is not meant to be a limitation. Rather, various operations may be performed in parallel (i.e., performed concurrently or partially concurrently), as practical. For example, operations relating to retrieval, watermarking, and/or adjusting of multiple files in a parallel or partially concurrent manner may be performed. As a further example, some operations could be performed concurrently using multiple instances of a process, such as multiple Watermarker instances or multiple Zip constructor instances. Operations such as retrieving files from storage may be done concurrently if the files are distributed across multiple storage facilities or may be grouped sequentially for files stored on the same storage host facility. For example, rather than access files File1.pdf and File2.pdf from storage during operations H and M, both files could be retrieved during operation H (or temporally proximate to operation H).

Under the foregoing embodiments, original file content is altered using a watermarking operation that is dynamically performed while a client file request is being serviced. However, embodiments of the invention are not limited to watermarking. Rather, the inventive approach may be used for other types of file alteration operations under which the size and/or CRC32 of the altered file content is not known in advance of the file alteration operation. For example, a similar scheme may be implemented using a file alteration operation comprising compression or encryption, wherein a compression or encryption operation is substituted for the watermarking operations described and illustrated herein. As another option, a combination of watermarking, compression, and/or encryption may be implemented in a similar manner. On a more generalized level, various other types of file alternation operations that are dynamically performed while servicing a client request for one or more files may be implemented in a similar manner.

In one embodiment, an encryption operation may be performed on one or more requested files, wherein the encryption operation employs a parameter that is unique to a user of a client making a request or unique to the particular request. For example, the returned Zip archive file may include individual files that are encrypted using indicia relating to a user's account, such as a user's login name, a user's password, or a password entered by the user in connection with requesting the files.

It shall be understood that the use of streaming content herein is not to imply that content is continuously being streamed from a server to a client. In some instances, there may be periods of relatively short duration under which content may not be being streamed, wherein the durations of the periods are less than the HTTP connection timeout period defined by the HTTP connection such that the full Zip archive file content is transferred to the client in response to a single HTTP request. For example, there may be situations where the streaming of a local file header is completed prior to completion of an alteration operation of a corresponding file, resulting in a small delay before the content for the file entry corresponding to the local file header can begin to be streamed. However, for purposes herein, including the claims, portions of the Zip archive file content are considered to be dynamically generated as other portions are being streamed, whether or not there are short periods when no streaming is occurring.

The techniques disclosed here are advantageous over current techniques. As discussed above, the conventional approach for streaming Zip archive content that is dynamically generated is to use the streaming Zip archive format, which is not compatible with some file archive utilities. Under the conventional approach for returning multiple files to a client, the entire Zip archive file is generated prior to streaming any of the file content, typically resulting in delays that are perceivable to users. In browser's such as Google Chrome, there is no dialog box or separate window indicating a requested file is being downloaded, but rather this is indicated by a representation of the file being added at the bottom of the browser window. In cases under which there is a delay in showing the representation, users may think there request was not received, often leading to multiple request for the same content. Under the approach disclosed herein, portions of the archive file may be streamed as they are dynamically generated, resulting in the perception from the user that the request is (substantially) immediately being serviced.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software components, modules and/or applications, such as software running on a real or virtual machine. Thus, embodiments of this invention may be used as or to support a software program, software modules, and/or distributed software executed upon some form of processing core (such as the CPU of a computer, one or more cores of a multi-core processor), a virtual machine running on a processor or core or otherwise implemented or realized upon or within a machine-readable medium. A machine-readable medium includes any mechanism for storing or transmitting information in a form readable by a machine (e.g., a computer). For example, a machine-readable medium may include a read only memory (ROM); a random access memory (RAM); a magnetic disk storage media; an optical storage media; and a flash memory device, etc.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings.

Rather, the scope of the invention is to be determined entirely by the following claims, which are to be construed in accordance with established doctrines of claim interpretation.

What is claimed is:

1. A method, comprising:
in response to a request from a client to receive one or more files, each having original content;
dynamically generating a Zip archive file having a standard Zip archive format, the Zip archive file including altered file content corresponding to a first file of the one or more files that is dynamically generated by altering the original content of the file using a file alteration operation employing at least one parameter that is not known in advance of the request such that a size of the altered file content is unknown prior to it being generated; and
streaming a first portion of the content corresponding to the Zip archive file content to the client while a second portion of the Zip archive file content is being dynamically generated.

2. The method of claim 1, wherein the altered file content is generated by:
determining at least one parameter to be employed by a watermarking algorithm after the request from the client to receive one or more files is received; and
performing a watermarking operation on the file using the watermarking algorithm while servicing the request from the client for the one or more files.

3. The method of claim 2, wherein the one or more files includes multiple files, and wherein the method further comprises:
for each of the multiple files,
performing a watermarking operation on the file to produce watermarked file content;
and dynamically adding the watermarked file content to the Zip archive file content while servicing the request from the client for the one or more files.

4. The method of claim 1, further comprising:
determining a size of the original content for the first file;
determining an overestimated size of an altered version of the first file and including the overestimated size as a file entry size in a local file header for a Zip archive file entry corresponding to the first file; and
adjusting a length of the altered file content corresponding to the first file such that a size of the file entry in the Zip archive file corresponding to the first file matches the overestimated size.

5. The method of claim 1, further comprising:
generating a local file header for the a Zip archive file entry corresponding to the first file including a predetermined CRC32 value; and
adding a CRC32 adjustment to content corresponding to the file entry such that a CRC32 calculation of the first entry including the CRC32 adjustment matches the predetermined CRC32 value.

6. The method of claim 5, wherein the CRC32 value is 2D1442EF

7. The method of claim 1, wherein a portion of the Zip archive file content begins to be streamed substantially immediately in response to receiving the request from the client to receive the one or more files.

8. The method of claim 1, wherein the one or more files includes multiple files, and wherein the method further comprises:
for each of the multiple files,
performing an alteration operation on the file to produce altered file content;
and dynamically adding the altered file content to the Zip archive file content as a portion of the Zip archive file content is being streamed to the client.

9. The method of claim 1, wherein the file alteration operation comprises a compression operation.

10. The method of claim 1, wherein the file alteration operation comprises an encryption operation.

11. The method of claim 1, further comprising:
identifying a user of the client; and
employing indicia unique to the user as a parameter implemented by the alteration operation.

12. A method, comprising:
in response to a request for a plurality of files from a client,
streaming Zip archive file content including the plurality of files to the client, wherein the Zip archive file content includes at least one file that is dynamically watermarked while the Zip archive file content is being streamed, and wherein the Zip archive file content is formatted as a standard Zip archive file that is dynamically generated.

13. The method of claim 12, further comprising dynamically watermarking each of the plurality of files as the Zip archive file content is being streamed.

14. The method of claim 12, further comprising:
generating a recipe identifying files to be included in the Zip archive file and defining at least a portion of a watermark to be applied to the at least one file that is dynamically watermarked; and
employing the recipe to generate the Zip archive file content and to dynamically watermark the at least on file.

15. The method of claim 12, further comprising:
for each of the at least one file that is dynamically watermarked,
determining an overestimated size of a watermarked version of the file and including the overestimated size as a file entry size in a local file header for a Zip archive file entry corresponding to the file; and
adjusting a length of the watermarked file content corresponding to the file such that a size of the file entry in the Zip archive file corresponding to the file after it is watermarked and adjusted matches the overestimated size in the local file header.

16. The method of claim 12, further comprising:
for each of the at least one file that is dynamically watermarked,
generating a local file header for the a Zip archive file entry corresponding to the file including a predetermined CRC32 value; and
adding a CRC32 adjustment to content corresponding to the file entry such that a CRC32 calculation of the entry including the CRC32 adjustment matches the predetermined CRC32 value.

17. The method of claim 12, wherein all of the files are dynamically watermarked after receiving the request for the plurality of files from the client.

18. The method of claim 12, further comprising:
identifying a user of the client; and
employing indicia unique to the user to watermark that at least one file that is dynamically watermarked.

19. A method comprising:
receiving a request from a client for a plurality of files; and
streaming content comprising a Zip archive file having a standard, non-streaming format to the client, wherein the Zip archive file is generated by,
for each of the plurality of files,
generating a local file header including an overestimated file entry size for a corresponding file entry to be generated and a predetermined CRC32 value;
performing an alteration operation on the file resulting in an alteration to an original content of the file, producing altered file content;
adding padding to the altered file content; and
adding a CRC32 adjustment to the altered file content and the padding to produce a Zip archive file entry corresponding to the file; and
generating central directory information associated with the Zip archive file entry,
wherein the size of the Zip archive file entry matches the overestimated file entry size in the local file header and a CRC32 calculation on the file entry will return a CRC32 value matching the predetermined CRC32 value.

20. The method of claim 19, wherein the alteration operation comprises a watermarking operation.

21. The method of claim 20, wherein the watermarking operation watermarks each file with indicia unique to at least one of:
a user of the client,
the request for the plurality of files,
a service provider performing the method to service the request, and
an originator of the file content.

22. The method of claim 20, further comprising:
generating a recipe identifying files to be included in the Zip archive file and defining at least a portion of a watermark to be applied to each of the plurality of files; and
employing the recipe to generate the Zip archive file content and to dynamically watermark each of the plurality of files.

23. The method of claim 19, further comprising:
in response to receiving, at a Web server, a request for the plurality of files an formatted as an HTTP 1.1 request, generating a local file header for a first file entry and streaming the local file header from the Web server to the client in a first portion of an HTTP 1.1 response that is sent substantially immediately after the HTTP 1.1 request is received; and
transferring a remainder of the Zip archive file content from the Web server to the client during the HTTP 1.1 response as one or more portions that are sent subsequent to the first portion of the HTTP 1.1 response.

24. A system comprising:
a plurality of servers configured in a multi-tier architecture including a Web server configured to service requests from clients, wherein the system is configured to service a request for a plurality of files from a client by performing operations via execution of a plurality of software instances implemented on at least one of virtual and physical machines, the operations comprising:
streaming Zip archive file content including the plurality of files from the Web Server to the client, wherein the Zip archive file content includes at least one file that is dynamically watermarked while the Zip archive file content is being streamed, and wherein the Zip archive file content is formatted as a standard Zip archive file that is dynamically generated.

25. The system of claim 24, wherein the multitier architecture includes a Zip archive file constructor tier comprising at least one instance of a Zip archive file constructor configured to dynamically construct Zip archive file content having a standard Zip archive file format.

26. The system of claim 24, wherein the multitier architecture includes a watermarker tier comprising at least one instance of a watermarker that is configured to receive watermarking indicia and watermark files employing the watermarking indicia.

27. The system of claim 24, wherein the multitier architecture includes an application tier comprising at least one instance of an application configured to receive information from the Web server relating to a request for a plurality of files and generate a recipe identifying files to be included in the Zip archive file and defining at least a portion of a watermark to be applied to each of the plurality of files.
